(19) United States
(12) Patent Application Publication
(10) Pub. No.: US 2006/0084463 A1
(43) Pub. Date: Apr. 20, 2006

(54) Mobile communication terminal having emergency call function and method of processing emergency call request in the mobile communication terminal

(75) Inventors: Sang-Hoon Yoo, Anyang-si (KR); Bum-Jin Jung, Seoul (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seoul (KR)

(21) Appl. No.: 11/046,847

(22) Filed: Feb. 1, 2005

(30) Foreign Application Priority Data
Oct. 4, 2004 (KR) 10-2004-0078616

(51) Int. Cl. H04M 1/00

(52) U.S. Cl. 455/550.1

(57) ABSTRACT

Disclosed herein are a mobile communication terminal equipped with a subscriber identification module and a method of processing an emergency call request in the mobile communication terminal. The mobile communication terminal includes: a keypad; a display unit; a RF module for communicating with a base station; and a controller for performing the overall control of the mobile communication terminal, the controller including: a PIN code input request unit for displaying a PIN code input request on the display unit when terminal booting is requested; a key data analysis unit for analyzing key data inputted through the keypad when the PIN code input request unit requests to input the PIN code; and an emergency call processing unit for searching for the base station and establishing a call connection to the base station when the key data is determined to be an emergency call request by the key data analysis unit.

### BACKGROUND OF THE INVENTION

This application claims priority to Korean Patent Application No. 2004-78616, filed on Oct. 4, 2004, in the Korean Intellectual Property Office, the entire contents of which are hereby incorporated by reference.

1. Field of the Invention

The present invention relates to a mobile communication terminal and, more particularly, to a mobile communication terminal equipped with a subscriber identification module.

2. Description of Related Art

A subscriber identification module, which refers to a detachable Subscriber Identification Module (SIM) or User Identification Module (UIM), has been introduced to make secure subscriber authentication in preparation for illegal duplication and use of a mobile phone and international roaming use. The SIM has been introduced in the early GSM-based mobile communication system. The UIM refers to CDMA SIM card standard developed after the introduction of the SIM.

The subscriber identification module (commonly referred to as ‘SIM card’) is a smart card, which is constructed of a microprocessor and a memory chip. The memory chip of the SIM card stores subscriber information, such as a user's personal phone number, an identification number, or account data, and network registration information necessary for the user to use a mobile communication service offered through a mobile communication network.

When the mobile communication terminal equipped with the SIM card is turned on by the user, a terminal control unit first detects the SIM card using a SIM card interface. Subsequently, the control unit requests to input a personal identification number (PIN) code to boot the terminal normally. The PIN code input request is performed only when the PIN code request is enabled. The terminal provides the user with a setting menu for PIN code request enable/disable.

When the user inputs the PIN code according to the PIN code input request, the terminal provides the user with a communication function and additional functions after accessing the SIM card and carrying out a normal booting procedure. The PIN code is used to prevent the unauthorized use of the terminal. However, if the user does not recollect the PIN code, the user cannot make an emergency call in case of a sudden emergency such as a fire.

### SUMMARY OF THE INVENTION

The present invention provides a mobile communication terminal equipped with a subscriber identification module enabling a user to make an emergency call even if he/she does not know a PIN code in an environment where a PIN code input request is enabled upon booting the terminal.

The present invention also provides a mobile communication terminal capable of preventing making a call after making an emergency call in the terminal where a PIN code input request is enabled.

In accordance with an aspect of the present invention, there is provided a mobile communication terminal equipped with a subscriber identification module in which a PIN code request is enabled, comprising: a keypad; a display unit; a RF module for communicating with a base station; and a controller for performing the overall control of the mobile communication terminal, comprising: a PIN code input request unit for displaying a PIN code input request on the display unit when terminal booting is requested; a key data analysis unit for analyzing key data inputted through the keypad when the PIN code input request unit requests to input the PIN code; and an emergency call processing unit for searching for the base station and establishing a call connection to the base station when the key data is determined to be an emergency call request by the key data analysis unit.

The controller may further comprise an emergency call termination processing unit for releasing the connection to the base station when an emergency call is terminated.

The emergency call processing unit may transmit terminal information to the base station upon establishing the call connection.

The terminal information to be transmitted to the base station may be one or both of an ESN (electronic serial number) and a MIN (mobile identification number).

In accordance with another aspect of the present invention, there is provided a method of processing an emergency call request in a mobile communication terminal equipped with a subscriber identification module, comprising the steps of: requesting to input a PIN code when terminal booting is requested; determining whether or not a key value inputted upon requesting to input the PIN code indicates an emergency call origination request; and searching for a base station and establishing a call connection to the base station when the key value is determined to indicate the emergency call origination request.

The method may further comprise the step of releasing the connection to the base station when an emergency call is terminated.

Terminal information may be transmitted to the base station upon establishing the call connection.

The terminal information transmitted to the base station may be one or both of an ESN and a MIN.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram showing the construction of a mobile communication terminal in accordance with a preferred embodiment of the present invention; and

FIG. 2 is a flowchart showing an emergency call process in a mobile communication terminal in accordance with a preferred embodiment of the present invention.

### DETAILED DESCRIPTION OF THE INVENTION

Exemplary embodiments of the present invention will now be described below in more detail with reference to the accompanying drawings. Like numerals refer to like elements throughout the specification.

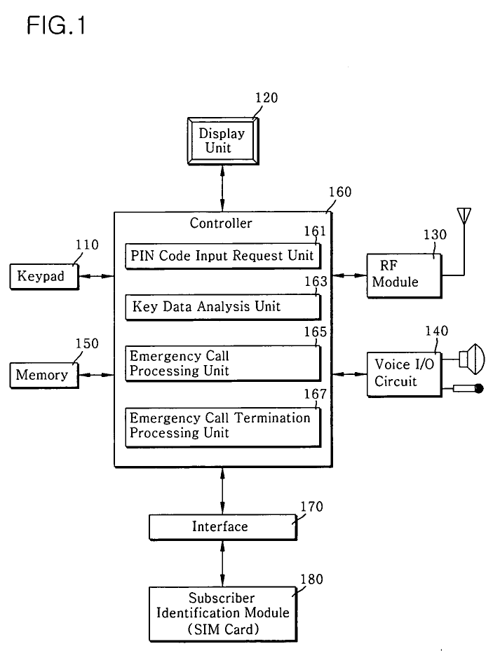

FIG. 1 is a schematic block diagram showing the construction of a mobile communication terminal in accordance with a preferred embodiment of the present invention. The mobile communication terminal includes typical components of a conventional mobile communication terminal, such as a keypad 110, a display unit 120 for displaying a menu and an operation state, a radio frequency (RF) module 130 for extracting voice and data signals from a radio signal transmitted/received over an antenna, a voice input/output (I/O) circuit 140 for inputting/outputting a voice communication signal from the RF module 130 through a microphone and a speaker, a memory 150 for storing control program data used to control the overall operation of the mobile communication terminal, and a controller 160 for controlling the overall system.

The display unit 120 may be a display device such as a liquid crystal display. The RF module 130 may include an antenna and an RF circuit for communicating with a base station. The voice I/O circuit 140 is a well-known component, which converts a digital voice signal into an analog voice signal or vice versa, and includes an additional circuit such as an audio amplifier or a filter.

A baseband circuit of the RF module 130 and most circuits of the controller 160 are provided as a single integrated circuit that is commercialized. The integrated circuit, usually referred to as a mobile station modem (MSM) chip, includes built-in dedicated hardware for processing communications, a digital signal processor and a general-purpose microprocessor. Each of parts constituting the controller 160 can be constructed of dedicated hardware, software, or a combination of them.

The mobile communication terminal having such a basic configuration is equipped with a subscriber identification module 180 in accordance with the present invention. The subscriber identification module 180 is generally referred to as ‘SIM card’ as described above. The subscriber identification module 180 stores subscriber information, such as a user's personal phone number, an identification number and account data, and network registration information necessary for the user to use a mobile communication service offered through the mobile communication network in its internal memory. The subscriber identification module is well-known in the art, and its detailed description will thus be omitted.

A standard of the SIM card 180 makes use of a contact scheme where a card reader and a card exchange information through a physical contact. The terminal controller 160 accesses information of the SIM card 180 through the interface 170 that is physically contacted with the SIM card 180. An interface standard of a terminal main body and the SIM card is well known in the art, and its detailed description will thus be omitted.

In accordance with an embodiment of the present invention, the controller 160 includes a PIN code input request unit 161, a key data analysis unit 163, and an emergency call processing unit 165. When terminal booting is requested, the PIN code input request unit 161 displays a PIN code input request on the display unit 120 in order to boot the terminal normally. The terminal booting is requested upon power-on of the terminal using the keypad 110.

When the PIN code input request is displayed on the display unit 120 by the PIN code input request unit 161, the user inputs a PIN code value or a key value for an emergency call request through the keypad 110. Preferably, the key value for the emergency call request represents a request for emergency call origination on a typical phone. For instance, the key values for 911 emergency rescues may be numerals of 9, 1, and 1 followed by a SEND key.

The key data analysis unit 163 analyzes key data inputted upon a request of the PIN code input request unit 161. The key data analysis unit 163 has a key automata function for analyzing key data that are inputted from the keypad 110 to the key buffer. In accordance with a preferred embodiment of the present invention, when numerals of 9, 1 and 1 followed by the SEND key are sequentially inputted to the key buffer under a PIN code input environment, the key data analysis unit 163 having the key automata function determines that there is a request for emergency call origination. That is, the terminal has an algorithm for analyzing whether or not a request for emergency call origination has been made under the PIN code input environment for booting. A technique for analyzing key codes inputted to the key buffer is well-known in the art, and its detailed description will thus be omitted.

When a user is determined to have requested the emergency call origination according to analysis of the key data analysis unit 163, the emergency call processing unit 165 first establishes a connection to the base station in order to perform a call connection process for an emergency call origination, since the PIN code has not been inputted and thus a connection to the base station is not yet established.

A description will now be given of a connection establishment between a mobile communication terminal and a base station. The mobile communication terminal acquires stored primary and secondary frequency channel information. The mobile communication terminal is tuned to the primary frequency channel and then acquires a pilot channel within a predetermined time. If the terminal cannot acquire the pilot channel from the primary frequency channel within the predetermined time, the same task is tried in the secondary frequency channel. If the pilot channel is not acquired from the secondary frequency channel, a task of acquiring the pilot channel is performed in other frequency channels.

Once the pilot channel is acquired, the mobile communication terminal and the base station are synchronized in time by acquiring a synchronization channel, and synchronization channel message information including SID (System ID), NID (Network ID) or the like is offered to the base station. In this manner, in the CDMA environment, the mobile communication terminal performs a call processing operation after establishing a connection to the base station. The connection establishment technique is well known in mobile communication systems such as GSM or CDMA, and a detailed description will thus be omitted.

After establishing a connection to the base station, the emergency call processing unit 165 performs a call origination process using an emergency call number inputted from the keypad 110. Then, the base station receives the origination call from the mobile communication terminal and establishes a call connection to an emergency rescue center, a fire fighting agency, and the like.

Accordingly, in accordance with the present invention, in the mobile communication terminal equipped with a subscriber identification module which requests a user to input a PIN code upon booting, the user can make an emergency call even when he/she cannot recollect the PIN code and thus cannot boot the terminal normally.

In accordance with another preferred embodiment of the present invention, the controller 160 further includes an emergency call termination processing unit 167. The emergency call termination processing unit 167 releases the connection with the base station when a call connection for the emergency call processed in the emergency call processing unit 165 is released. When the connection with the base station is released by the emergency call termination processing unit 167, the PIN code input request unit 161 preferably requests again the PIN code input through the display unit 120.

Accordingly, the mobile communication terminal in accordance with the present invention releases the connection with the base station established in a state where the terminal is not booted normally and then controls incoming and originating call connections, so that an unauthorized person cannot make a call and battery power consumption can be reduced.

In accordance with another preferred embodiment of the present invention, the emergency call processing unit 165 transmits terminal information to the base station when processing a call connection. Generally, an emergency call is connected to the base station without carrying out a special algorithm for authenticating the terminal. Accordingly, the base station can identify a current call as an emergency call, but not obtain information about a subscriber of the terminal. Accordingly, the emergency call processing unit 165 preferably transmits terminal information to the base station when processing an emergency call origination.

Examples of the terminal information to be transmitted to the base station include an electronic serial number (ESN) and/or a mobile identification number (MIN). Here, the ESN is stored in the memory 150 of the terminal, and the MIN is stored in the subscriber identification module 180. For reference, since the ESN is not given to the terminal in the GSM scheme, the terminal information to be transmitted to the base station is the MIN.

The base station tracks the location of the corresponding terminal and manages it on the basis of the terminal information transmitted from the mobile communication terminal. Preferably, a network-based location tracking technology can be applied for location tracking. The network-based location tracking technology is a base station oriented location tracking scheme where a user's location is tracked based on the time difference of arrival or the angle of arrival of signals received from a plurality of base stations. Examples of the network-based location tracking technology include a TOA (Time of Arrival) scheme, a TDOA (Time Difference of Arrival) scheme, and an AOA (Angle of Arrival) scheme.

The TOA scheme is a scheme where a distance between the terminal and the base station is obtained by measuring a propagation delay time therebetween, and the location of the terminal is determined by obtaining a point in which circles that are centered at a plurality of base stations overlap each other.

The TDOA scheme is a scheme where a location is determined using the time difference of arrival of signals transmitted from different places. In other words, the location of the terminal can be determined by measuring propagation time differences of arrival of signals which are proportional to differences in distances between a plurality of base stations and the terminal, and solving for the mathematical intersection of multiple hyperbolas based on the time difference of arrival of signals. The location measurement based on the TDOA scheme determines the location of the terminal by a triangulation scheme by using a time difference when a correlation value is highest using a cross correlation method.

The AOA scheme is a location measurement scheme where a location is determined by measuring the angel of arrival of a signal transmitted from a receiver in a signal source. The AOA is measured under the assumption that the signal is in line of sight (LOS) but LOS signal may not be received in the area such as the microcell where reflections and diffractions occur due to crowded buildings. In this situation, the estimation is done based on AOA of the reflected signal, if it is the strongest, and therefore the location estimated differs greatly from the real one.

Other location tracking technologies in the base station are well-known in the art, and their detailed description will thus be omitted.

Accordingly, in accordance with the present invention, the base station can efficiently track the location of the mobile communication terminal that has made an emergency call.

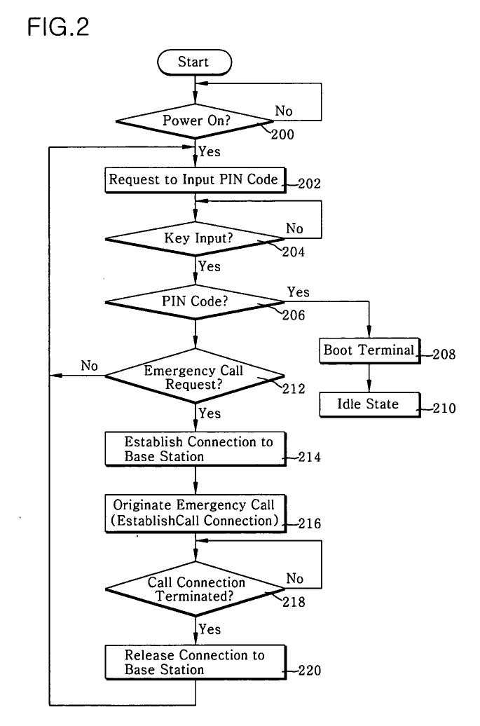

FIG. 2 is a flowchart showing an emergency call process in a mobile communication terminal equipped with the SIM card 180 in accordance with a preferred embodiment of the present invention. First, when a user sends a power-on command through the keypad 110 to the terminal which is powered off, the controller 160 displays a PIN code input request on the display unit 120 to have an access to the SIM card 180 (steps 200 and 202).

The controller 160 determines whether or not a key is input from the keypad 110 under a PIN code input condition (step 204). If the key is input, the controller 160 analyzes the key and determines whether or not it is a PIN code (step 206). If the key is the PIN code, the controller 160 performs terminal booting, and the terminal controller 160 that has been completely booted maintains an idle state (steps 208 and 210).

When the key data inputted in the PIN code input condition is determined to be an emergency call origination request, the controller 160 establishes a connection to the base station as described above (step 212). Subsequently, according to the user's request, the controller 160 performs the emergency call origination process and establishes a call connection to the base station (steps 214 and 216). Preferably, the controller 160 also transmits terminal information such as ESN and MIN to the base station at the same time when it performs the emergency call origination process in the step 216. Meanwhile, if both the PIN code input request and the emergency call origination request are not satisfied as the analysis result of the key data inputted in the above-mentioned steps, the controller 160 carries out the step 202 again to request the PIN code input.

When the call connection according to the emergency call request is terminated, the controller 160 releases the connection to the base station (steps 218 and 220) since the connection to the base station no longer needs to be established. After releasing the connection to the base station in the step 220, the controller 160 preferably displays the PIN code input request of the step 202 on the display unit 120.

As described above, the mobile communication terminal according to the present invention, which is equipped with the subscriber identification module and requests the PIN code input when it is booted, can offer an emergency call function in an emergency when a user cannot remember or know the PIN code.

In addition, since the mobile communication terminal releases a connection to the base station which has been established while the terminal is not normally booted, it is possible to prevent an unauthorized person from making a call and thus to prevent unnecessary battery consumption.

Further, since the mobile communication terminal offers terminal information to a base station upon establishing an emergency call connection, the base station can efficiently track the location of the terminal.

While the present invention has been described with reference to exemplary embodiments thereof, it will be understood by those skilled in the art that various changes in form and details may be made therein without departing from the scope of the present invention as defined by the following claims.

What is claimed is:

1. A mobile communication terminal equipped with a subscriber identification module in which a PIN code request is enabled, comprising:
a keypad;
a display unit;
a RF module for communicating with a base station; and
a controller for performing the overall control of the mobile communication terminal, comprising:
a PIN code input request unit for displaying a PIN code input request on the display unit when terminal booting is requested;
a key data analysis unit for analyzing key data inputted through the keypad when the PIN code input request unit requests to input the PIN code; and
an emergency call processing unit for searching for the base station and establishing a call connection to the base station when the key data is determined to be an emergency call request by the key data analysis unit.

2. The mobile communication terminal of claim 1, wherein the controller further comprises an emergency call termination processing unit for releasing the connection to the base station when an emergency call is terminated.

3. The mobile communication terminal of claim 1, wherein the emergency call processing unit transmits terminal information to the base station upon establishing the call connection.

4. The mobile communication terminal of claim 2, wherein the emergency call processing unit transmits terminal information to the base station upon establishing the call connection.

5. The mobile communication terminal of claim 3, wherein the terminal information to be transmitted to the base station is one or both of an ESN (electronic serial number) and a MIN (mobile identification number).

6. The mobile communication terminal of claim 4, wherein the terminal information to be transmitted to the base station is one or both of an ESN and a MIN.

7. A method of processing an emergency call request in a mobile communication terminal equipped with a subscriber identification module, comprising the steps of:
requesting to input a PIN code when terminal booting is requested;
determining whether or not a key value inputted upon requesting to input the PIN code indicates an emergency call origination request; and
searching for a base station and establishing a call connection to the base station when the key value is determined to indicate the emergency call origination request.

8. The method of claim 7, further comprising the step of releasing the connection to the base station when an emergency call is terminated.

9. The method of claim 7, wherein terminal information is transmitted to the base station upon establishing the call connection.

10. The method of claim 8, wherein terminal information is transmitted to the base station upon establishing the call connection.

11. The method of claim 9, wherein the terminal information transmitted to the base station is one or both of an ESN and a MIN.

12. The method of claim 10, wherein the terminal information transmitted to the base station is one or both of an ESN and a MIN.
